(19) United States
(12) Patent Application Publication
(10) Pub. No.: US 2013/0105670 A1
(43) Pub. Date: May 2, 2013

(54) PULSED LASER SIGNAL DISRUPTING DEVICE INCORPORATING LED ILLUMINATOR

(71) Applicant: Marko Borosak, Zagreb (HR)

(72) Inventor: Marko Borosak, Zagreb (HR)

(21) Appl. No.: 13/807,025

(22) PCT Filed: Jul. 2, 2010
(86) PCT No.: PCT/HR10/00020

§ 371 Date: Dec. 27, 2012

(51) Int. Cl. G01J 1/18

(52) U.S. Cl. CPC G01J 1/18
USPC 250/214.1

(57) ABSTRACT

The invention discloses a pulsed-laser signal disrupting device incorporating a high intensity LED illuminator including a pulsed-laser detector, pulsed-laser beam emitting source, high intensity and efficiency LED illuminator, microcontroller and a user interface. A microcontroller algorithm detects a foreign pulsed-laser signal and performs disruption with automatic camouflaging of the disruption signal source.

### FIELD OF INVENTION

Invention relates to pulsed laser signal disrupting device incorporating LED illuminator, where the pulsed laser signal source that is being disrupted is a video LIDAR device, a device that is a combination of a previous LIDAR device and a video camera which records the view area of a LIDAR device and the target within it.

### SUMMARY OF INVENTION

The present invention relates to pulsed laser signal disrupting device incorporating LED illuminator.

The preferred embodiment describes an optical pulsed-laser detector wherein the optical signal is converted to an electrical signal, a pulsed-laser beam emitting source preferably a semiconductor laser diode wherein the electrical signal is converted to an optical signal, a high intensity and efficiency LED illuminator preferably containing plurality of infra red or visible light emitting diodes which is a signaling or illuminating source, a microcontroller that is connected to all above segments and a user interface through which the user of the device controls the functions and receives information from the device.

The microcontroller controls the presence of a foreign pulsed laser beam detecting process through the use of a pre-stored algorithm, where said algorithm utilizes pulsed-laser detector and a database of frequencies of known malicious foreign pulsed laser beam sources. Said algorithm also controls the foreign pulsed laser beam signal disrupting process, where said process additionally utilizes pulsed-laser beam emitting source to send a disrupting pulsed laser signal. Laser detector property enables the illuminator to operate automatically in specific conditions. If signal is recognized in a database an alert will be given through the user interface to warn the device operator, disrupting process will be initiated by sending out transmitting commands to a pulsed-laser beam emitting source with the same frequency as the detected signal and in phase with the detected signal but always a few hundred ns in advance, and an activation command will be given to a high intensity LED illuminator so both visible light and IR light are emitted from a sensor compartment. This way a device sensor during a disrupting process is visible and perceived as a lit fog lamp, consequently IR laser flicker is overexposed and not noticeable on a video LIDAR reproduction screen.

### PREVIOUS STATE OF ART

A common type of laser based obstacle detector device is one that emits a powerful and very short laser beam pulse (in the time range from 1 ns to several 100 ns) and detects the reflection if one is present from the object.

By using a precise timing mechanism which measures the time of flight (TOF) of the emitted laser pulse to its return as a reflection from the target, it is possible to measure the targets distance by using the speed of light constant (LIDAR Light Detection And Ranging) (cf. U.S. Pat. No. 5,359,404 Dunne). A laser beam of such a device can be coherent or diverging. A coherent beam will lead to pinpoint targeting, in combination with a rotating sensor head the device becomes a laser scanner device. A diverging beam leads to reduced range of detection since the beam progressively gets wider as distance increases but the chance of hitting a smaller target increases.

Laser beam detectors are a main part of any LIDAR device; they are utilized to detect a returning laser echo signal. However, laser beam detectors are present and are used as standalone devices as well. Usual applications of Laser beam detector devices are in military, police, safety and other counter acting devices. One particular application as disclosed in the U.S. Pat. No. 5,347,120 DECKER, is a detector of a pulsed-laser “radar” signal that is emitted by a police vehicle speed measuring instrument. Such a device warns the user that his vehicle is being targeted by a speed measuring LIDAR device.

In my previous invention WO/2009/133414 BOROSAK, I have disclosed an improved circuit and method for detecting a pulsed-laser beam signal which optimizes reception of weak signals in varying sun and temperature conditions.

It is important to understand that a Laser beam detector that is an integral component of a LIDAR device can also detect foreign signals simultaneously if such an embodiment is required.

A laser beam detector can also be an integral part of a foreign pulsed-laser signal disrupting device (LIDAR jammer, U.S. Pat. No. 5,767,954 LAAKMANN). Such a device is similar to a LIDAR device. It contains a pulse transmitting, receiving and computing component. The computing component in this case is used for recognizing malicious foreign pulsed-laser signals, discriminating a signal from interference and calculating the proper disrupting signal to be transmitted.

The principle of operation was described in the mentioned invention in 1996 as prior art where it says “Proposed lidar jammers would operate by transmitting the jamming laser beam a pulse train having a pulse repetition frequency that matches the pulse repetition frequency of the monitor laser beam transmitted by the lidar speed monitor.”

Following the U.S. Pat. No. 5,767,954 LAAKMANN from year 1996 to year 2010 there have been several other documented inventions which have improved or claimed to improve a LIDAR signal disrupting (LIDAR jamming) process. One of such invention U.S. Pat. No. 6,833,910 BOGH-ANDERSEN claims to improve this process by transmitting a disrupting signal having a second (different) pulse repetition frequency than the one of a LIDAR device that is being disrupted to the contrary of the described prior art method of U.S. Pat. No. 5,767,954 LAAKMANN.

In the 2003 a video LIDAR device has been introduced, U.S. Pat. No. 6985827 WILLIAMS. Such a device is a combination of a previous LIDAR device and a video camera which records the view area of a LIDAR device and the target within it. Usually a center of a recorded video is dominated by a crosshair placed on the targeted vehicle (in the case of a vehicle speed measuring video LIDAR). This improvement of a LIDAR device has enabled that a video evidence is created of a LIDAR operators actions which makes it easier to interpret the measurement results later on. Since the LIDAR unit within a video LIDAR device is usually the same as in the case of a stand-alone LIDAR device, the signal disrupting process that is successful on a LIDAR device will also be successful on a video LIDAR device.

However none of the following inventions have addressed the following problem that arises with the introduction of video LIDAR systems.

The video camera component in the video LIDAR device is usually based on a CCD or CMOS chip. Such video sensor chips are sensitive to visible light (human eye), from 400-700 nm, but they are also sensitive to the near infra red light from 700-1000 nm; (PHYSICS-BASED VISION: HEALEY, SCHAFER, WOLFF). In some video camera embodiments this infra red sensitivity is filtered out so it would not affect the reproduction to be different than perceived by a human eye. Most cameras in video LIDAR devices make use of this effect and translate near infra red light as a white or red light. Since a LIDAR signal in most LIDAR devices is generated by a 905 nm wavelength laser diode, its wavelength is 905 nm, making it visible to the video component of a video LIDAR. What is more important is that in order for a LIDAR disrupting signal to be effective it must as well be in the 905 nm wavelength, consequently revealing the source of disruption on the video recording screen as a bright shining light source. Since signal disruption is a process that is preferably not to be detected, revelation of a disruption source on a video reproduction screen presents a problem for LIDAR signal disrupting devices. Thus far no inventions have dealt with this particular problem but in the present invention a solution will be described.

Using LED, Light Emitting Diodes as illuminating devices in vehicles has been described by several documented inventions. U.S. Pat. No. 4,733,335 SERIZAWA, discloses a vehicular lamp consisting of plurality of light emitting diodes, condenser lens, diffusion lens, housing and supporting board. Later invention U.S. Pat. No. 5,490,049 MONTALAN discloses a signaling light for a motor vehicle having a plurality of light emitting diodes, optical arrangements, outer plate, a cover and printed circuit boards. Most of the claims of the mentioned inventions regard to the manufacture and assembly process for such an illuminating device for a vehicle. The second invention claims to improve some of the manufacturing and servicing parameters of the original invention.

### DETAILED DESCRIPTION OF THE INVENTION

A pulsed laser signal disrupting device incorporating LED illuminator has been disclosed. Below are underlined definitions of the invention parts and corresponding short explanation of their technical functions.

The plurality of LEDs are central part of the high intensity illuminator. They emit an infra red or visible light or the combination of the two. It is a source of signaling or illuminating light.

The malicious foreign pulsed laser signal is any foreign LIDAR signal that is intentionally aimed at the device or at a vehicle carrying the device without the knowledge and consent of the devices or vehicle operator.

The database means are used to store frequencies or signal patterns of malicious pulsed-laser (LIDAR) sources of interest to a device operator. This way an incoming signal can be screened against the database content and signals of interest can be recognized.

The user interface means are a one way or a two way communication components used to communicate information, commands or indications from the device to a user, from user to the device or both ways.

The program storage means are any type of read only memory device which can be a stand-alone device connected to a microcontroller or can be an integral part of the microcontroller itself.

The speed of vehicle is a speed at which a vehicle that is carrying the device is travelling, and is measured by microcontroller via connection to a vehicle speed signal line usually found on standardized vehicle connectors.

### BRIEF DESCRIPTION OF THE DRAWINGS

FIG. 1 shows a block diagram of the circuit showing how a microcontroller is controlling the detection and transmission of laser signals as well as the emission of signaling or illuminating light. Connection to user interface is also shown.

FIG. 2 shows preferred physical embodiment of the Laser Sensor with shown laser sensing, transmitting and illuminating light source component positions.

FIG. 3 shows a circuit schematic of a microcontroller module and user interface module. Connections to the laser sensor illuminator module and a USB optional jack are also shown.

FIG. 4 shows the laser transmitter circuit schematic showing the overcurrent protection circuit, power supply, laser diode with an output transistor, driver circuit and impulse conditioning circuit.

FIG. 5 shows the high intensity LED illuminator circuit schematic showing a plurality of visible and/or infra red LEDs, output transistor and driver.

FIG. 6 discloses the flow chart describing the alternative program algorithm of the microcontroller.

### DETAILED DESCRIPTION

The presented circuit is to be used as a detector and disrupter of foreign pulsed-laser beams directed at a vehicle or an object thus comprising a counter-measure to the pulsed-laser device. Such counter-measures that comprise the presented circuit will obtain camouflaging ability against detection by the video pulsed-laser (video LIDAR) systems.

The base method of the disrupting process used is as described by U.S. Pat. No. 5,767,954 LAAKMANN in the prior art section. Measuring LIDAR instrument sends out a laser pulse train of usually fixed and known repetition frequencies. This and such LIDAR frequencies are pre-stored in a microcontroller database of a presented invention as malicious pulsed-laser patterns.

A pulsed-laser detector component of a presented device will detect the arrival of laser pulses and will convert optical signals to electrical impulses which are then sent to a microcontroller unit. The pulsed-laser detector component used in the presented invention is documented in my previous invention WO/2009/133414 BOROSAK, “Pulsed-Laser detector with improved sun and temperature compensation”.

Frequency of said electrical signals will be discriminated by the microcontroller program logic against the database to screen out interference, non-malicious sources or not yet stored signals. If signal is recognized in a database an alert will be given through the user interface to warn the device operator, disrupting process will be initiated by sending out transmitting commands to a pulsed-laser beam emitting source with the same frequency as the detected signal and in phase with the detected signal but always a few hundred ns in advance, and an activation command will be given to a high intensity LED illuminator so both visible light and IR light are emitted from a sensor compartment. This way a device sensor during a disrupting process is visible and perceived as a lit fog lamp, consequently IR laser flicker is overexposed and not noticeable on a video LIDAR reproduction screen.

### PREFERRED EMBODIMENT

The circuitry and the functional detail of the preferred embodiment in accordance with the invention will be explained in detail in the following paragraphs.

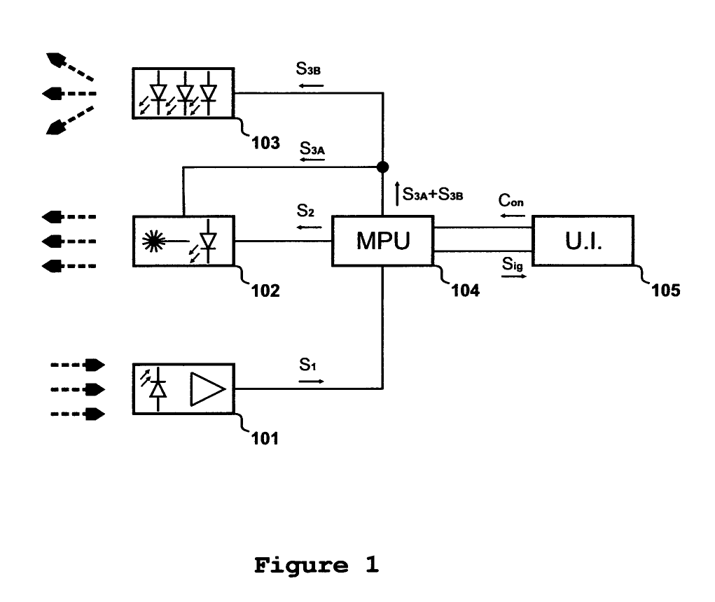

FIG. 1 illustrates the block diagram of a pulsed-laser obstacle avoidance device with high intensity LED illuminator according to the present invention.

A microcontroller unit 104 according to an algorithm creates an electrical pulse signal S₂ that is sent to a pulsed-laser beam transmitter 102. Pulsed-laser beam transmitter 102 converts electrical pulse signal to an optical laser beam pulse that is emitted in front towards the direction of a possible target. Strength of emitted optical laser beam pulse is regulated by a S_{3A} signal that is also generated by the microcontroller unit 104 and fed to the pulsed-laser beam transmitter 102. In a case when an obstacle is present in front of the device and strength of the transmitted optical laser pulse was sufficient, reflected echo optical pulse will trigger a pulsed-laser detector 101 and S₁ electrical signal will be generated. The S₁ signal is brought to the microcontroller unit 104 where the microcontroller algorithm translates reception of the S₁ signal and according S_{3A} strength regulation signal to a specific distance to the obstacle. The microcontroller algorithm further creates a user alert signal S_{ig} that corresponds to the determined distance to the obstacle, and also a S_{3B} signal that activates a high intensity LED illuminator. In a case when an obstacle is present in front of the device but strength of the transmitted optical laser pulse was not sufficient, reflected echo optical pulse will be too weak to trigger the pulsed-laser detector 101. In that case the microcontroller algorithm will adjust S_{3A} strength regulation signal to a higher setting and the procedure will be repeated until the obstacle is found or a maximum setting of the S_{3A} strength regulation signal is reached.

The user interface 105 contains key switches through which a user can change sensitivity and other settings of a detection process. It also contains audio visual electronic components which convert electrical S_{ig} alert signal to audio visual alerts.

A pulsed-laser detector 101 used in a preferred embodiment is one documented in WO/2009/133414 “pulsed-laser beam detector with improved sun and temperature compensation” invention.

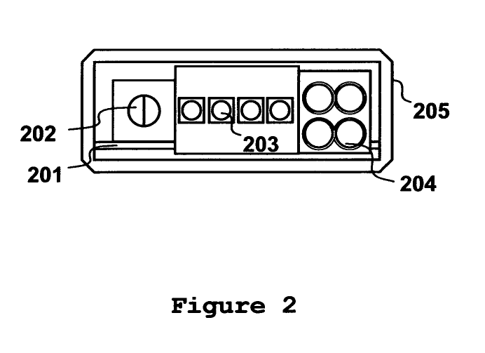

With reference to FIG. 2 the preferred physical embodiment is disclosed. The devices outer sensor unit is shown with a cross section showing metal casing 205, printed circuit board 201 holding the electronic components of the device, a pulsed laser diode 202 that converts the electrical transmission signal into an optical signal, high intensity light emitting diodes 203 that are used as a signaling or illuminating light source and a plurality of photo-detectors 204 that are connected in parallel and convert reflected or external optical signals in to electrical signals.

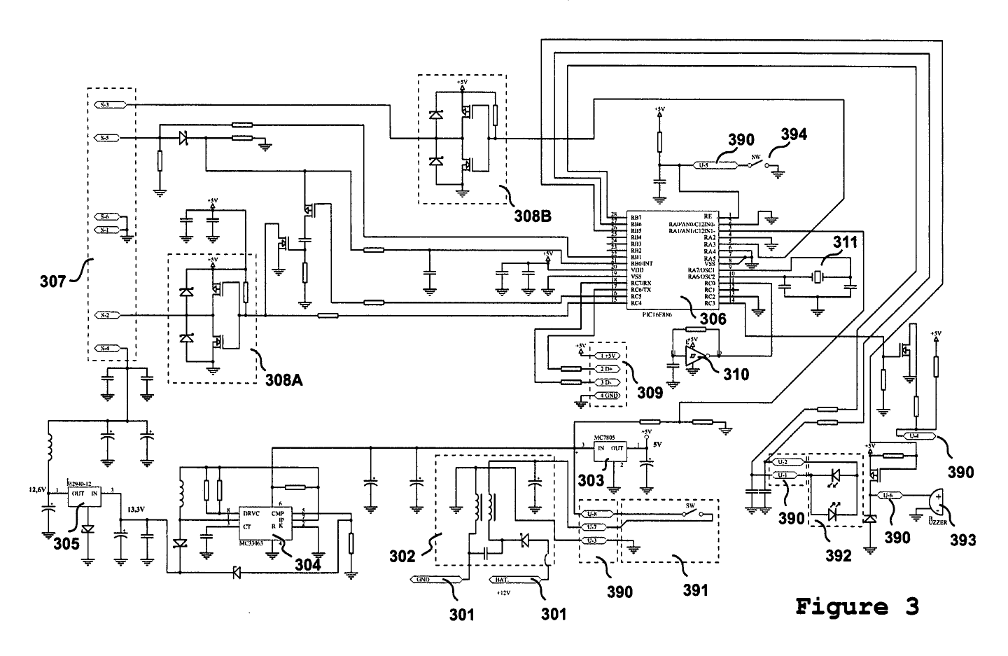

With reference to FIG. 3 the preferred embodiment will be disclosed in detail. Power supply terminals 301 connect to a vehicles power line which is usually powered by a +12 V DC battery. Electric current is filtered in a noise filter 302 that removes spikes, voltage drops and similar from the supply current. Over current fuse and reverse polarity protection are integral parts of the noise filter 302. Filtered power lines are then fed to the first voltage regulator 303 preferably OnSemi MC7805 which outputs a power supply of reduced 5 V voltage and second step-up switching voltage regulator 304 preferably OnSemi MC33063 which outputs an increased 13.3 V voltage. Second voltage regulator's 304 output is connected to a third LDO voltage regulator 305 preferably a National LM2940-12 which reduces 13.3 V voltage to a stable 12.6 V voltage level that is now stable independently of a voltage level at main power supply terminals 301.

5 V voltage supply is needed for the operation of TTL level lines and a microcontroller 306 preferably a Microchip PIC16F886. A 12.6 V voltage supply is needed for the operation of outer sensors that receive their power supply through the S-4 line. S-1 and S-6 lines to outer sensor are ground connecting lines.

Connecting lines S-1, S-2, S-3, S-4, S-5 and S-6 present connections to an outer sensor and are preferably realized through a RJ12 6 pin Modular connector 307.

Connecting lines U-1, U-2, U-3, U-4, U-5, U-6, U-7 and U-8 present connections to a user interface and are preferably realized through a RJ45 8 pin Modular connector 390.

Microcontroller unit 306 has a connection to a clock source oscillator 311 preferably a 20 MHz crystal, secondary oscillator 310 preferably a Fairchild NC7WZ14 oscillating gate, to outer sensor lines 307, to user interface lines 390 and to serial external device port 309.

Transmission of a pulsed-laser beam signal is initiated by a microcontroller 306 by setting the S-2 line to a 5 V high voltage level for an initial pulse of 200 ns in duration. The transmission output pin of a microcontroller 306 RC4 is buffered and inverted by a CMOS-fet driver circuit 308A preferably consisting of Onsemi 2N7002 and BSS84 complementary transistors.

The echo electrical signal from outer sensor's pulsed-laser detector is returned over a S-5 line to RB0 and RB1 microcontroller 306 inputs.

The S-3 line is also buffered by an inverting CMOS buffer 308B and is connected to microcontroller 306 RA3 pin. Over this line a laser pulse strength regulation signal S_{3A} is transferred as well as a high intensity LED illuminator activation/deactivation command signal S_{3B}, both created by a microcontroller 306. Both signals travel on the same S-3 line but since they are different in frequency and duration they do not affect each other.

User interface consists of a power switch and a ground line connection 391, two color signaling LED 392 preferably Kingbright L-57EGW, a buzzer 393 preferably CUI CEM-1205C, and a controlling key button 394 preferably TYCO MSPS103C0. Through the user interface the device operator will receive alert information and is able to control the parameters of device operation.

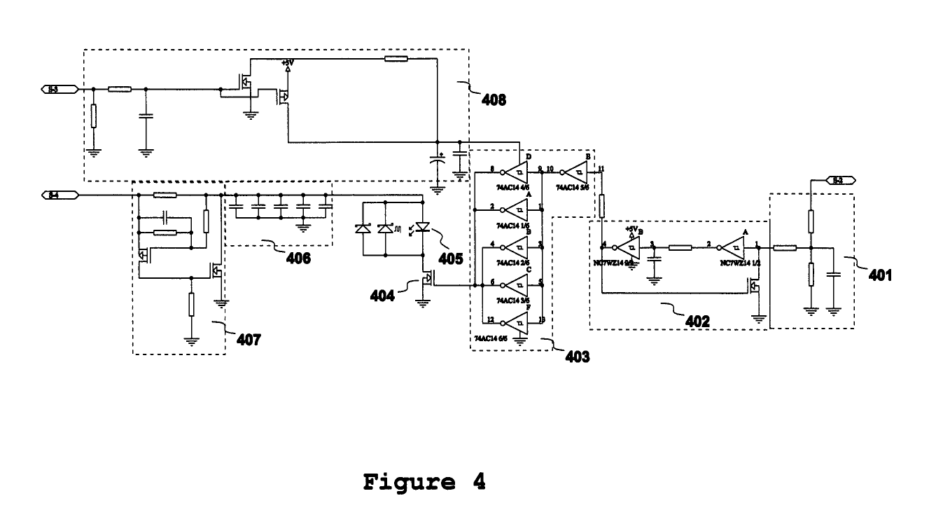

FIG. 4 discloses a pulsed-laser beam transmitter circuit as part of an outer sensor unit. Transmission command signal enters the circuit through the S-2 input connector and is brought to a filtering RC combination of components 401. Any noise accumulated over the connecting cable is filtered out and only 5 V TTL level impulses are passed through to a pulse conditioning circuit 402. Pulse conditioning circuit 402 is preferably realized with Fairchild NC7WZ14 inverting gates pair connected in series through an R-C signal shortening element combination. This way any length of signal entering the circuit will be shortened to approximately 30 ns in length. Conditioned transmission signal now enters a driver integrated circuit 403, preferably consisting of Fairchild 74AC14 hex Schmitt inverter gates connected in parallel. Signal current potential is now increased and is brought to a laser diode output transistor 404, preferably International Rectifier IRLL014N. The output transistor 404 converts the trigger signal into a high current signal through a laser diode 405. The laser diode 405, preferably Osram SPLPL90_{—}3 converts a part of the electrical energy given by a high current to optical laser energy which radiates towards the potential targets. Source of the high current high speed energy is an array of fast storage capacitors 406 consisting of preferably Murata 470 nF capacitors.

In case of a fault and overcurrent has started flowing through the laser diode 405 an overcurrent protection circuit 407 will activate and disengage the laser diode 405 from the current circuit. Electrical power to the whole circuit is supplied over an S-4 line.

Regulation of emitted laser pulse strength is achieved by applying a regulation signal over the S-3 line which feeds a laser strength regulation circuit 408, preferably containing a combination of OnSemi 2N7002 and BSS84 MOS-fet transistors. The regulation process regulates the power supply voltage level of the driver circuit 403 and thus the peak voltage level of transmission signal impulses, consequently altering the optical laser pulse strength.

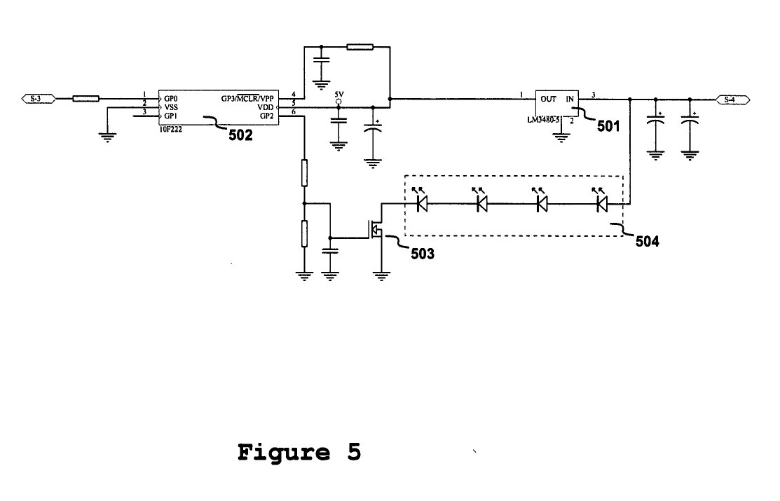

As disclosed in FIG. 5, a high intensity LED illuminator circuit is shown. Power supply is fed to the circuit through an S-4 power supply line, equally as for the pulsed-laser transmitter 102 and pulsed-laser detector 101 circuit segments. The power supply of 12.6 V voltage is brought to a voltage regulator 501, preferably realized with a National LM3480-5 device, which converts it to a 5 V level that is used by a LED driver 502 component. LED driver 502 preferably a Microchip 10F222 component receives activation and deactivation commands over an S-3 line which is connected to GP0 input of the component. LED driver 502 uses pulse width modulation on its GP2 output pin to achieve various driving levels for the output transistor 503. Various driving levels will result in output transistor 503, preferably an OnSemi 2N7002 varying the current of a high intensity LEDs 504 and thus varying the intensity of emitted light. Light intensity parameter is set up in the LED driver 502 prior assembly. High intensity LEDs 504 are preferably realized with Osram CN5M-GAHA components which are latest generation light emitting diodes with very high efficiency of 73 lm/W. Availability of such high efficiency devices in a small 5 mm package has allowed for integration as the present invention has shown.

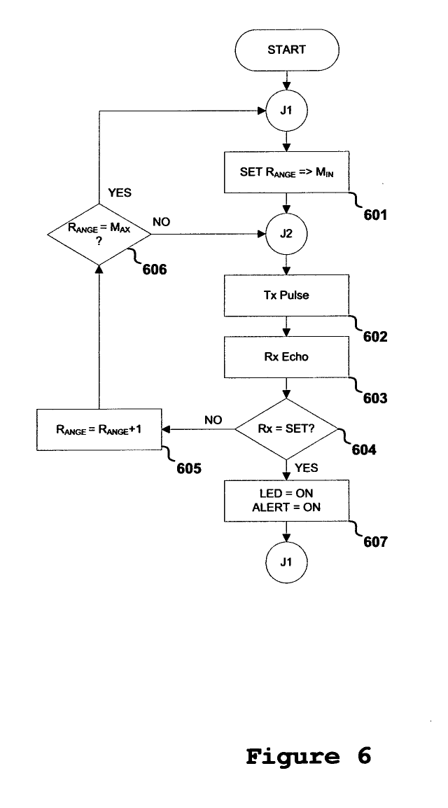

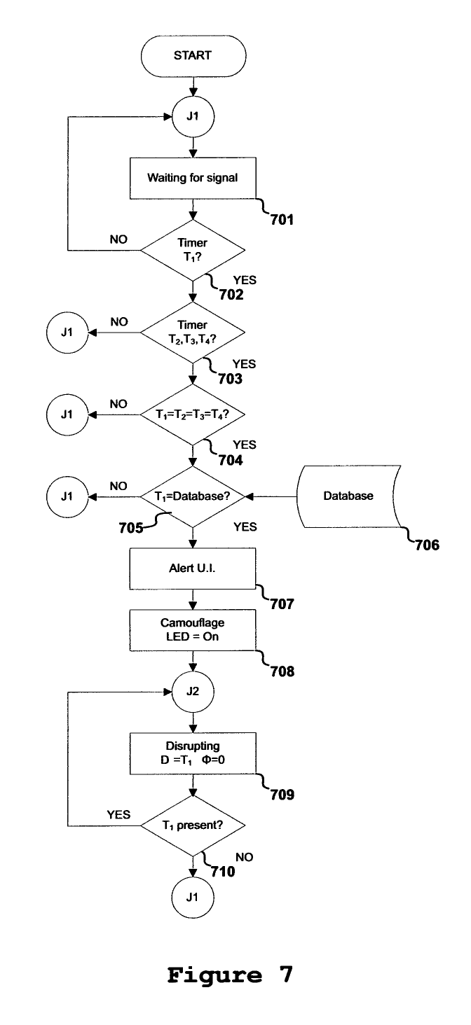

The logic of the algorithm is illustrated by the flow charts on FIG. 6. Said Microchip PIC16886 microcontroller has available 256 8-bit registers that present its RAM memory.

Variables used by the program logic are located in the RAM registers. The microcontroller ROM memory is preferably used for storing the Program code, Database data and Constants and should be pre-programmed adequately.

All the Constants and the Database data used in the program logic are located in the said ROM memory locations.

Construction of the Microchip PIC16F886 microcontroller is such that one instruction cycle takes four periods of the crystal oscillator 311 signal—that is feeding the microcontroller 306. Preferably, the clock frequency of the crystal oscillator 311 is adjusted to 20 MHz which results in one instruction cycle time of 200 ns. Resolution of a microcontroller's timer unit is 200 ns as well which is not sufficient for time-of-flight method of operation, in that case a separate precise timing module can be implemented or a microcontroller with 16-bit, 32-bit or 64-bit registers and higher operation frequency can be selected.

In preferred embodiment the microcontroller 104 program logic will function as pulsed-laser signal detection and disrupting device.

The logic of an alternative embodiment algorithm is illustrated by the flow chart FIG. 6. The startup routine is given by the block 701.

The block 701, program is waiting for an interrupt signal from pulsed-laser detector, no operation commands are executed but in a different embodiment other tasks could be executed while waiting for an interrupt to occur. Such other task are exchanging information with a second remote pulsed-laser device or obstacle detection and avoidance.

Triggering of a pulsed-laser detector creates an interrupt and program exits the waiting routine 701.

Next, program 702 initiates signal period timing by a microcontroller 104 timer unit. Time period between first two pulses of the detected signal T₁ is stored in memory and program proceeds to timing of the subsequent signal periods T₂, T₃ and T₄ between second, third, fourth and fifth pulse respectively, block 703. Signal periods T₂, T₃ and T₄ are also stored in memory.

In case a second pulse did not arrive within a time window of 60 ms timer of block 702 will abort T₁ timing procedure and return to the start-up routine 701. Pulsed laser signal sources of interest have smaller period time than said time window which allows that they be detected and most noise signals to be filtered out.

Similarly in block 703 timing procedure will also be aborted and program returned to the start-up routine 701 if any period timing exceeds the said time window limit.

Stored signal periods T₁ to T₄ are compared 704 and must match each other within a predetermined tolerance window for the program to proceed. Tolerance window in this embodiment is setup at 0.01% of the period time. Program returns to the start-up routine 701 if the discrepancy exceeds set tolerance window.

Program proceeds to database verification step 705 where measured signal period T₁ is compared to the content of a prestored signals of interest (LIDARs) period database 706. If match is found between measured signal period T₁ and database content program proceeds, otherwise program execution is returned to the start-up routine 701.

Next, the program initiates an alert to a device operator 707 via user interface, warning light and buzzer are activated. Then program activates LED illumination component 708 which in this embodiment comprises visible light LEDs. Visible light illumination in the vicinity of pulsed laser beam transmitter over-exposes the video camera segment of a LIDAR that is aimed at the device and that has caused an alert. LIDAR operator recognizes the additional illuminating spot on his screen but visual confirmation indicates an ordinary visible light lamp instead of a infra red only light source indicative of a disrupting device.

Program then begins to emit a disrupting signal 709 which has T₁ time period and is emitted synchronous with the foreign signal. This way maximum possible signal disruption is achieved and foreign signal pulses are masked with additional disrupting pulses.

As long as foreign signal pulses are detected by a pulsed-laser beam detector at the expected T₁ time the disrupting signal is synchronized to them and emitted 710. If foreign signal ceases the disrupting process is suspended and additional time of 4 seconds is given in the waiting period of routine 710 for it to reappear after which the alerts and the disrupting process are aborted and program returns to the start-up routine 701.

It should be understood that the invention is not limited by the embodiments described above, but is defined solely by the claims.

1-9. (canceled)

10. A pulsed-laser signal disrupting device incorporating a LED illuminator comprising:
a pulsed-laser beam detector;
a pulsed-laser beam transmitter;
an LED illuminator;
a microcontroller with program storage means, and
user interface means,
wherein the microcontroller program logic records any foreign pulsed-laser signal pattern received via pulsed-laser beam detector, compares the recorded pattern with a pre-stored database of malicious signals, and if detected as malicious—informs a user via the user interface means and automatically initiates transmission of disrupting signals via the pulsed-laser beam transmitter that match in frequency with the foreign signal received, and
wherein, the LED illuminator is automatically activated at that time to disguise the signal disrupting source.

11. The device of claim 10 wherein said LED illuminator comprises visible light LEDs, infrared light LEDs or their combination.
